(19) United States
(12) Patent Application Publication
(10) Pub. No.: US 2026/0364666 A1
(43) Pub. Date: Nov. 19, 2026

(54) SPRING WIRE FOR PRODUCING A COIL SPRING, COIL SPRING, AND METHOD FOR PRODUCING A COIL SPRING

(71) Applicant: BRAND KG, Anroechte (DE)

(72) Inventors: Daniel KLEINEHEILMANN, Lippstadt (DE); Joerg RUHOSE, Anroechte (DE); Ingo ROHMANN, Erwitte (DE); Heiko SALM-SCHROEDER, Anroechte (DE)

(73) Assignee: BRAND KG, Anroechte (DE)

(21) Appl. No.: 19/738,409

(22) Filed: Jul. 11, 2026

Related U.S. Application Data
(63) Continuation of application No. PCT/DE2024/100295, filed on Apr. 9, 2024.

(30) Foreign Application Priority Data
Jan. 11, 2024 (DE) 10 2024 100 796.6

(51) Int. Cl. B21F 19/00; B21F 35/00; F16F 1/02

(52) U.S. Cl. CPC B21F 19/00; B21F 35/00; F16F 1/024

(57) ABSTRACT

A spring wire for producing coil springs. The spring wire has a spring wire core having a martensitic structure, a circumferential surface delimiting the spring wire core on the outside, and a carrier layer that is formed on the entire circumferential surface of the spring wire core, with a circumferential surface delimiting the carrier layer on the outside. A spring wire corrosion protection layer is applied to the entire circumferential surface of the carrier layer. A coil spring and a method for producing a coil spring are also provided.

This nonprovisional application is a continuation of International Application No. PCT/DE2024/100295, which was filed on Apr. 9, 2024, and which claims priority to German Patent Application No. 10 2024 100 796.6, which was filed in Germany on Jan. 11, 2024, and which are both herein incorporated by reference.

### BACKGROUND OF THE INVENTION

### Field of the Invention

The invention relates to a spring wire for producing coil springs, comprising a spring wire core having a martensitic structure, a circumferential surface delimiting the spring wire core on the outside, and a carrier layer that is formed on the entire circumferential surface of the spring wire core, with a circumferential surface delimiting the carrier layer on the outside. The invention further relates to a coil spring and to a method for producing same.

### Description of the Background Art

Different examples of spring wires, coil springs made from a spring wire, and the production of coil springs are already known from the prior art.

### SUMMARY OF THE INVENTION

It is therefore an object of the present invention to improve a spring wire for producing a coil spring, a coil spring, and a method for producing a coil spring.

To achieve the object, the invention is characterized in that a spring wire corrosion protection layer is applied to the entire circumferential surface of the carrier layer. The carrier layer is preferably designed as a diffusion layer made of zinc and iron with an intermetallic phase. This object is further achieved by a coil spring and a method according to the invetnion.

A special advantage of the invention is that a spring wire for producing a coil spring, a coil spring, and a method for producing a coil spring are improved. A coil spring is cost-effectively achievable due to the inventive design of the spring wire, the coil spring, and the method for producing the coil spring,. This applies in particular to use of the coil spring according to the invention in the automotive field, and here in particular for use of the coil spring according to the invention as a compression spring in a drive for opening and closing a trunk lid or the like, wherein the corrosion protection of the coil spring, namely, of the spring wire used for this purpose, is essential for proper long-term functioning of the coil spring. In contrast to conventional methods, carrying out the coating of the spring wire core according to the invention before the coil spring according to the invention is produced from the spring wire formed therefrom is a much simpler production technique.

The spring wire can be freely selectable within wide appropriate limits according to its type, material, dimensions, and geometry, in particular the geometry of its cross section. For example, the spring wire may be a steel wire. However, this is not mandatory, and depends on the particular application. In addition, the application of the spring wire according to the invention is not limited to use of the spring wire according to the invention for springs, in particular coil springs.

The spring wire core can be designed as an alloyed and quenched/tempered spring wire core, preferably as an SiCr-alloyed and quenched/tempered spring wire core, particularly preferably as an SiCrV-alloyed and quenched/tempered spring wire core. The spring wire core of the spring wire according to the invention thus has a design that is particularly well suited for most applications, in particular in the automotive field. This is particularly true for the preferred, and especially for the particularly preferred, example of this refinement. The spring wire core has a martensitic structure. Accordingly, this results in a pretreatment of the spring wire core that is known per se to the person skilled in the art. “SiCr-alloyed” means an alloy containing silicon and chromium; “SiCrV-alloyed” means an alloy containing silicon, chromium, and vanadium. An SiCr alloy, in particular an SiCrV alloy, of the spring wire core ensures very good strength of the spring wire core. In addition to the alloy constituents mentioned above, the SiCr-alloyed and SiCrV-alloyed spring wire core may contain even further alloy constituents. Of course, other materials are also conceivable in principle for the spring wire core, for example using other alloys. Accordingly, the person skilled in the art may rely on the material that is suitable for this purpose, depending on the requirements of the individual case. The person skilled in the art is aware of the particular pretreatment of the spring wire core to be carried out.

Analogously to the spring wire core, the spring wire corrosion protection layer can also be freely selectable within wide appropriate limits according to its type, material, and dimensions. The spring wire corrosion protection layer is preferably designed as a zinc-aluminum layer, ZnAl layer for short, it being preferred that the zinc-aluminum layer has an aluminum fraction of up to 15%, preferably 3% to 7%, for example 5% (“Zn95Al5 layer” for short). In this way, a selection of the material of the spring wire corrosion protection layer is made that is particularly suitable for producing the coil spring according to the invention and for most applications. This is particularly true for applications in the automotive field. In this regard, see the above statements.

Prior to production of the coil spring, the spring wire can have a spring wire cross section over essentially its entire length that differs from a circular cross section, preferably that the spring wire has no mutually facing and mutually parallel boundary surfaces on the circumferential surface side. It is thus possible, for example, to design the geometry of the cross section of the spring wire according to the invention of the coil spring according to the invention in a targeted manner before the coil spring according to the invention is actually produced from this spring wire. For example, before the coil spring is produced, the geometry of the cross section of the spring wire according to the invention could be designed so that after the coil spring according to the invention is produced from this spring wire, a cross section of the spring wire that is desired for the coil spring, for example an essentially circular spring wire cross section of the coil spring, results.

The spring wire can have a wire cross section over essentially its entire length such that the spring wire of a coil spring produced from this spring wire has two mutually facing and mutually parallel boundary surfaces on the circumferential surface side. The mutually parallel, circumferential surface-side boundary surfaces of the coil spring produced from the spring wire are preferably oriented perpendicularly or essentially perpendicularly to a longitudinal axis of the coil spring.

When assessing whether a boundary surface on the circumferential surface side is oriented perpendicularly to the longitudinal axis of the coil spring and/or whether two mutually facing boundary surfaces on the circumferential surface side extend in parallel to one another, the emphasis should be on the typical accuracy of the relevant work steps in producing such a coil spring, in particular on the accuracy in stamping the spring wire and coiling the coil spring. A production tolerance of ±2-3° in the perpendicular or parallel orientation of the boundary surfaces on the circumferential surface side should typically be taken into account.

For example, the spring wire may have a circular cross section prior to production of the coil spring. The coil spring produced from the spring wire then provides a cross section that is different from the circular geometry, for example an elliptical cross section.

The spring wire of the coil spring can be ground on at least one end-face end of the coil spring in such a way that in a use position of the coil spring, only this ground spring wire forms a support surface of the coil spring for force-transmitting support of the coil spring on this end-face end of the coil spring against an abutment, with the support surface extending essentially perpendicularly to the longitudinal axis of the coil spring. This enables a very simple design of the coil spring according to the invention, with a minimum of components for the coil spring according to the invention.

Only a separating surface of the coil spring created by severing the spring wire and a grinding surface of the coil spring can be created by the above-mentioned grinding of the spring wire of this end-face end of the coil spring are coated with a coil spring corrosion protection layer. On the one hand, this ensures corrosion protection of the coil spring according to the invention, namely, of the spring wire according to the invention, and on the other hand the complexity in producing the coil spring according to the invention is reduced. Thus, after the above-mentioned severing and grinding, the coil spring is not yet entirely coated with a corrosion protection layer, and instead only the created separating surface and the created grinding surface of the coil spring, namely, of the spring wire, are coated with a corrosion protection layer. For example, the separating surface and the grinding surface may be coated with the same coil spring corrosion protection layer, for example in a single work operation. The separating surface and the grinding surface may be coated in a manner known per se by the person skilled in the art. Of course, this also applies to the other coating according to the invention.

Furhter, measures are provided for reducing the tendency of the coil spring according to the invention to oscillate. For example, the diameter of the spring wire may vary in order to reduce the tendency of the coil spring to oscillate. For example, flocking of the circumferential surface of the spring wire or of the coil spring with plastic fibers may be provided. For applying the flocking, it is preferably provided to statically charge the coil spring and apply an adhesive, then apply the plastic fibers.

Further advantages, features, and particulars of the invention result from the further subclaims and the following description. The features mentioned therein, in each case alone or in any given combination, may be essential to the invention. Of course, features and details of the spring wire and of the coil spring described according to the invention also apply in conjunction with the method according to the invention, and vice versa. Thus, reciprocal reference may always be made to the disclosure with regard to the individual aspects of the invention. The drawings are used merely by way of example to clarify the invention, and are not limiting in nature.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows an example of the coil spring according to the invention made from the spring wire according to the invention, in a perspective illustration of the coil spring blank,

FIG. 1b shows the example in an illustration analogous to FIG. 1a, showing the coil spring blank after grinding an end-face coil spring end,

FIG. 1c shows the example in an illustration analogous to FIG. 1b, showing the coil spring blank after coating of the separating surface and the grinding surface,

FIG. 2a shows the example in a top view of the above-mentioned end-face coil spring end after being ground, and

FIG. 2b shows the example in an illustration analogous to FIG. 2a, after coating of the separating surface created by the separation, and after coating of the grinding surface created by the grinding.

### DETAILED DESCRIPTION

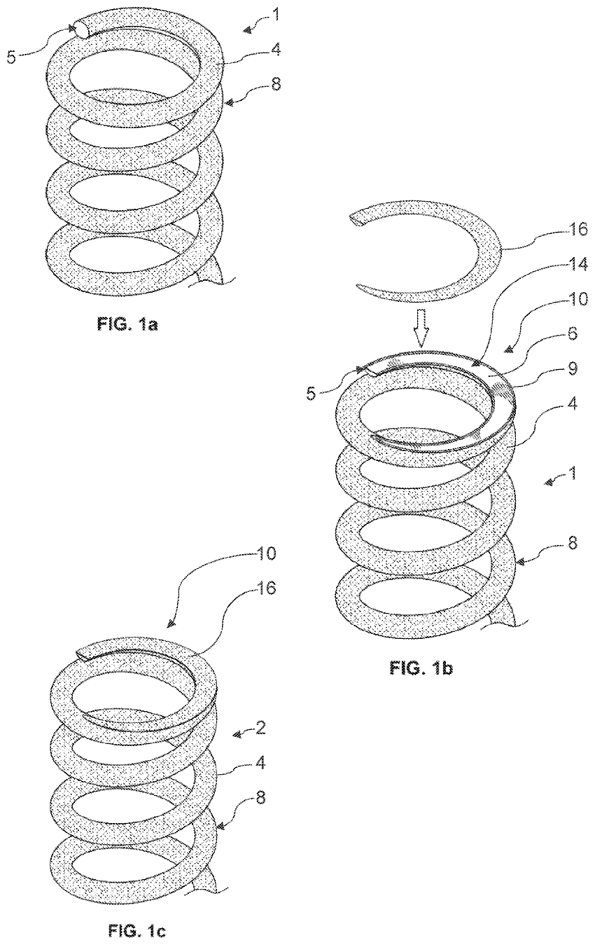

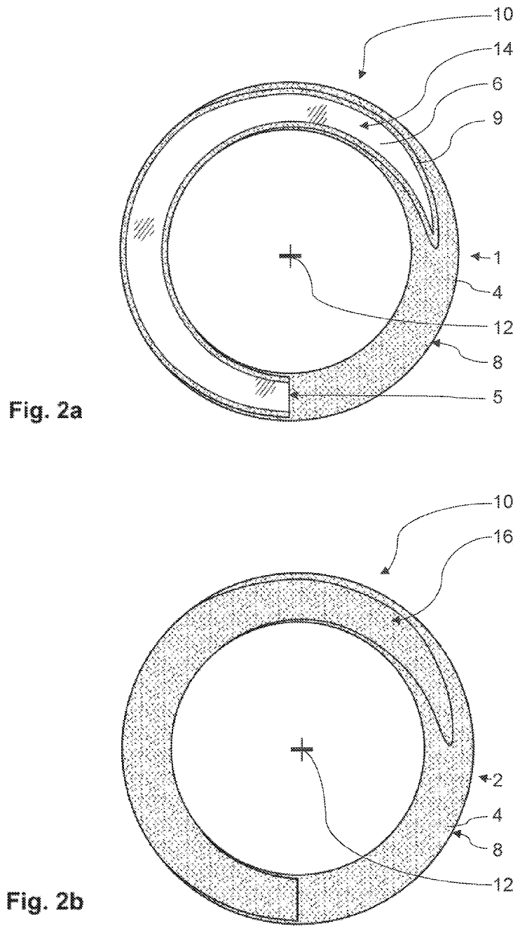

FIGS. 1a through 2b illustrate an example of the coil spring according to the invention strictly by way of example.

The coil spring 2 has a suitable design for use in the automotive field, namely, as a compression spring in a drive for opening and closing a trunk lid of a motor vehicle. The motor vehicle together with the trunk lid and the drive is not explicitly illustrated.

The coil spring 2 is produced from a spring wire 4, wherein the spring wire 4 comprises a spring wire core 6 having a martensitic structure, a circumferential surface delimiting the spring wire core 6 on the outside, and a carrier layer that is formed on the entire circumferential surface of the spring wire core 6, with a circumferential surface delimiting the carrier layer on the outside. According to the invention, a spring wire corrosion protection layer 8 is applied to the entire circumferential surface of the carrier layer. In FIG. 1b the carrier layer is not illustrated individually, but, rather, is shown together with the spring wire corrosion protection layer 8 as a unit 9. The carrier layer is designed as a diffusion layer made of zinc and iron with an intermetallic phase.

In the present example, the spring wire core 6 is designed as an alloyed and quenched/tempered spring wire core 6, namely, as an SiCrV-alloyed and quenched/tempered spring wire core 6.

The spring wire corrosion protection layer 8 applied to the circumferential surface of the carrier layer is designed as a zinc-aluminum layer, with the zinc-aluminum layer having a aluminum fraction of approximately 5% here. In principle, the aluminum fraction may be up to 15%, preferably between 3% and 7%.

Furthermore, in the present example, the spring wire 4 has a spring wire cross section over essentially its entire length that differs from a circular cross section, namely, in such a way that the spring wire 4 has no mutually facing and mutually parallel boundary surfaces on the circumferential surface side. This spring wire cross section of the spring wire 4, which differs from a circular cross section, is not visible in FIGS. 1a through 2b. For simplification, the spring wire cross section of the spring wire 4 is illustrated as a circular cross section in the above-mentioned figures.

To produce the coil spring 2, the spring wire 4 of the coil spring 2 is ground on at least one end-face end 10 of the coil spring 2 in such a way that in a use position of the coil spring 2, i.e., after the coil spring 2 is installed in the motor vehicle, only this ground spring wire 4 forms a support surface of the coil spring 2 for force-transmitting support of the coil spring 2 on this end-face end 10 of the coil spring 2 against an abutment of the motor vehicle, with the support surface extending essentially perpendicularly to the longitudinal axis of the coil spring 2. In the image plane in FIGS. 2a and 2b, the longitudinal axis of the coil spring 2 extends perpendicularly to the respective image plane. In the image plane in FIGS. 2a and 2b, the longitudinal axis is symbolized in each case by a cross 12. The above-mentioned support surface of the coil spring 2 is situated in the image plane in FIG. 2b. FIG. 2a corresponds to FIG. 1b, and FIG. 2b corresponds to FIG. 1c. In principle, it is conceivable for only one of the two end-face ends of the coil spring according to the invention to be processed in the above manner. However, it is also possible for both end-face ends of the coil spring according to the invention to have been treated in the above manner.

In the present example, only a separating surface 5 of the coil spring 2 created by severing the spring wire 4 and a grinding surface 14 of the coil spring 2 created by the above-mentioned grinding of the spring wire 4 of the end-face end 10 of the coil spring 2 are coated with a coil spring corrosion protection layer 16. For the sake of clarity, the coil spring corrosion protection layer 16 in the image plane of FIG. 1b is situated above the separating surface 5 and the grinding surface 14. As previously stated in the introduction to the description, this coating as well as the other coating in the present example may be carried out in any suitable and meaningful manner known to the person skilled in the art. Strictly as an example, reference is made here only to the design of the coil spring corrosion protection layer as a zinc lamellar coating or cathodic dip coating (CDC).

The production of the spring wire according to the invention and also the method according to the invention for producing the coil spring according to the invention according to the present example are explained in greater detail below with reference to FIGS. 1a through 2b.

The method for producing the coil spring 2 comprises the following method steps in the stated order:

First, the spring wire core 6 is cleaned, for example pickled. On the cleaned spring wire core 6, zinc is subsequently applied to the circumferential surface of the spring wire core 6 by use of a molten zinc bath. A diffusion layer made of zinc and iron with an intermetallic phase forms on the circumferential surface of the spring wire core 6. The diffusion layer with the intermetallic phase is not individually illustrated in FIGS. 1a through 2b. Afterward, the spring wire corrosion protection layer 8 designed as a zinc-aluminum layer is applied to the circumferential surface of the carrier layer by use of a molten zinc-aluminum bath. The spring wire 4 with the overall coating 9 made up of the carrier layer and the zinc-aluminum layer 8 is now present.

In the present example, during production of the spring wire 4 the spring wire 4 undergoes a shaping treatment at least once so that, before the spring wire 4 is coiled to produce a coil spring blank 1 of the coil spring 2, the spring wire 4 has a spring wire cross section over essentially its entire length that differs from a circular cross section, namely, in such a way that prior to the above-mentioned coiling of the spring wire 4, the spring wire 4 has no mutually facing and mutually parallel boundary surfaces on the circumferential surface side. The above-mentioned shaping may be carried out, for example, in such a way that during the subsequent production of the coil spring 2 from the spring wire 4, the spring wire 4 has a spring wire cross section that forms an essentially circular cross section of the spring wire 4, and thus of the coil spring 2, over the entire length of the spring wire 4. The above-mentioned shaping may be carried out in any suitable manner known to the person skilled in the art. Strictly as an example, only rolling and stamping are mentioned here. However, such deformation of the spring wire is not absolutely necessary. Accordingly, examples of the spring wire according to the invention are also conceivable in which the spring wire is undeformed, i.e., used with a circular spring wire cross section for producing a coil spring.

To produce the coil spring 2 from the spring wire 4 that is now present, the spring wire 4 which has been manufactured in a known manner is coiled in a manner known per se to the person skilled in the art. The spring wire 4 is then coiled and separated using a coiling machine for producing the coil spring blank 1. The spring wire 4 is now ground on at least one end-face end 10 of the coil spring blank 1 in a manner known per se to the person skilled in the art, namely, in such a way that in the use position of the coil spring 2, i.e., in the above-mentioned installed position of the coil spring 2 in the motor vehicle, only this ground spring wire 4 forms a support surface of the coil spring 2 for force-transmitting support of the coil spring 2 on this end-face end 10 of the coil spring 2 against the abutment of the motor vehicle, with the support surface extending essentially perpendicularly to the longitudinal axis 12 of the coil spring 2. Lastly, only the separating surface 5 of the coil spring 2 created by the above-mentioned separation of the spring wire 4 and the grinding surface 14 of the coil spring 2 created by the above-mentioned grinding of the spring wire 4 of this end-face end 10 of the coil spring 2 are coated with the coil spring corrosion protection layer 16. In this regard, see an overview in FIGS. 1a through 2b. On the one hand, coating the separating surface 5 and the grinding surface 14 with the coil spring corrosion protection layer 16 is necessary for corrosion protection reasons, since the previously applied zinc-aluminum layer 8 of the spring wire 4 has been removed due to the above-mentioned separation of the spring wire 4 and grinding in the area of the grinding surface 14. On the other hand, it is sufficient to subsequently coat only the separating surface 5 and the grinding surface 14 with the coil spring corrosion protection layer 16, since the remaining coating on the spring wire 4 has not been damaged by the separation and grinding.

After the coil spring 2 is produced, it is preferably subjected to heat treatment. For example, the coil spring 2 is stress-relief annealed and/or tempered, and/or the coating is burned in and/or the coil spring 2 is heat-set, i.e., heated and driven to block in the heated state.

A coil spring 2 may be cost-effectively implemented due to the inventive design of the spring wire 4, the coil spring 2, and the method for producing the coil spring 2. This applies in particular to the above-mentioned use of the coil spring 2 in the automotive field, and here in particular for use of the coil spring 2 as a compression spring for the drive for opening and closing the trunk lid of the motor vehicle, wherein the corrosion protection of the coil spring 2, namely, of the spring wire 4 used for this purpose, is essential for proper long-term functioning of the coil spring. In contrast to conventional methods, carrying out the coating of the spring wire core 6 according to the invention before the coil spring 2 is produced from the spring wire 4 formed therefrom is a much simpler production technique. Of course, other spring wire corrosion protection layers and coil spring corrosion protection layers that are suitable for the specific application are also conceivable in principle. The method according to the invention for producing the coil spring according to the invention is correspondingly adaptable to other requirements.

The invention is not limited to the present example. For example, the invention may also be advantageously used for other applications, not just in the automotive field. As previously stated in the introduction to the description, the spring wire may be designed as a spring steel wire, for example. The above-mentioned terms “coiling” and “coiling machine” are to be generally construed here, and encompass all types of coiling and winding as well as all types of coiling machines or winding machines used for this purpose. In addition, besides the method steps explicitly stated above, the method according to the invention may include further method steps. This applies both for producing the spring wire core and for producing the spring wire according to the invention and the coil spring according to the invention. It is also pointed out that the coil spring corrosion protection layer 16 may be applied in any customary, suitable manner known to the person skilled in the art. Strictly as an example, only dipping, electrochemical coating methods such as CDC, spraying, imprinting, rolling, and brushing are mentioned here. To increase the durability of the coating, namely, of the coil spring corrosion protection layer 16, this coating may undergo a subsequent heat treatment such as burn-in, hardening, or drying of this coating. Of course, this also applies for the other mentioned coating. As an alternative to the coating means stated above, such as CDCs and zinc lamellar coatings, it is also possible to use other types of coatings, for example application of a single- or multi-component lacquer.

However, not just springs, in particular coil springs according to the invention, are producible from the spring wire according to the invention. It is also possible to advantageously produce other bent wire parts from the spring wire according to the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A spring wire to produce a coil spring, the spring wire comprising:
a spring wire core having a martensitic structure;
a circumferential surface delimiting the spring wire core on an outside;
a carrier layer that is formed on the entire circumferential surface of the spring wire core, with a circumferential surface delimiting the carrier layer on the outside; and
a spring wire corrosion protection layer is applied to the entire circumferential surface of the carrier layer.

2. The spring wire according to claim 1, wherein the spring wire core is an alloyed and quenched/tempered spring wire core or an SiCr-alloyed and quenched/tempered spring wire core or an SiCrV-alloyed and quenched/tempered spring wire core.

3. The spring wire according to claim 1, wherein the spring wire corrosion protection layer is a zinc-aluminum layer, or wherein the zinc-aluminum layer has an aluminum fraction of up to 15%, or 3% to 7%.

4. The spring wire according to claim 1, wherein the spring wire has a circular spring wire cross section over essentially its entire length, or wherein the spring wire of a coil spring produced from this spring wire does not have two mutually facing and mutually parallel boundary surfaces on the circumferential surface side.

5. The spring wire according to claim 1, wherein the spring wire has a spring wire cross section over essentially its entire length that differs from a circular cross section, or wherein the spring wire has no mutually facing and mutually parallel boundary surfaces on the circumferential surface side.

6. The spring wire according to claim 5, wherein the spring wire has a spring wire cross section over essentially its entire length such that the spring wire of a coil spring produced from this spring wire has two mutually facing and mutually parallel boundary surfaces on the circumferential surface side, and wherein the two mutually facing and mutually parallel boundary surfaces of the spring wire are oriented perpendicularly to a longitudinal axis of the coil spring produced from this spring wire.

7. A coil spring that is made from a spring wire according to claim 1.

8. The coil spring according to claim 7, wherein the spring wire of the coil spring is ground on at least one end-face end of the coil spring such that in a use position of the coil spring, only this ground spring wire forms a support surface of the coil spring for force-transmitting support of the coil spring on this end-face end of the coil spring against an abutment, with the support surface extending essentially perpendicularly to a longitudinal axis of the coil spring.

9. The coil spring according to claim 8, wherein only a separating surface of the coil spring created by severing the spring wire and a grinding surface of the coil spring created by the above-mentioned grinding of the spring wire of this end-face end of the coil spring are coated with a coil spring corrosion protection layer.

10. The coil spring according to claim 9, wherein the coil spring corrosion protection layer a zinc lamellar coating or a CDC.

11. The coil spring according to claim 7, wherein the spring wire of a coil spring produced from the spring wire does not have two mutually facing and mutually parallel boundary surfaces on the circumferential surface side.

12. The coil spring according to claim 7, wherein the spring wire in the produced coil spring has two mutually facing and mutually parallel boundary surfaces on the circumferential surface side, and wherein the boundary surfaces extending in parallel on the circumferential surface side are oriented perpendicularly to a longitudinal axis of the coil spring.

13. A method for producing the coil spring according to claim 7, the method comprising:
cleaning the spring wire core;
creating the carrier layer on the entire circumferential surface of the spring wire core;
applying the spring wire corrosion protection layer to an entire circumferential surface of the carrier layer;
coiling the spring wire produced in the above manner;
coiling the spring wire by use of a coiling machine and severing the spring wire to produce a coil spring blank;
grinding the spring wire on at least one end-face end of the coil spring blank such that in a use position of the coil spring, only this ground spring wire forms a support surface of the coil spring for force-transmitting support of the coil spring on this end-face end of the coil spring against an abutment, with the support surface extending essentially perpendicularly to a longitudinal axis of the coil spring; and
coating only a separating surface of the coil spring created by the above-mentioned severing of the spring wire and a grinding surface of the coil spring created by the above-mentioned grinding of the spring wire of this end-face end of the coil spring with a coil spring corrosion protection layer.

14. The method according to claim 13, wherein during production of the spring wire, the spring wire undergoes a shaping treatment at least once so that, before the spring wire is coiled to produce a coil spring blank, the spring wire has a spring wire cross section over essentially its entire length that differs from a circular cross section, or wherein prior to the above-mentioned coiling of the spring wire, the spring wire has no mutually facing and mutually parallel boundary surfaces on the circumferential surface side.

15. The method according to claim 13, wherein the coil spring blank and/or the coil spring are subjected to heat treatment or stress-relief annealed, and/or tempered, and/or heat-set, and/or wherein the coating is burned in.
